(19) United States
(12) Patent Application Publication
(10) Pub. No.: US 2014/0117196 A1
(43) Pub. Date: May 1, 2014

(54) CHASSIS ASSEMBLY AND ANTI-THEFT DEVICE THEREOF

(71) Applicants: HONG FU JIN PRECISION INDUSTRY (WUHAN), Wuhan (CN); HON HAI PRECISION INDUSTRY CO., LTD., New Taipei (TW)

(72) Inventors: Qing-Hui MI, Shenzhen (CN); Chen-Liang HUANG, New Taipei (TW); Guang-Yao LEE, New Taipei (TW)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/686,933

(22) Filed: Nov. 28, 2012

(30) Foreign Application Priority Data
Oct. 31, 2012 (CN) 2012104263581

(51) Int. Cl. F16M 11/06

(52) U.S. Cl. CPC F16M 11/06
USPC 248/551

(57) ABSTRACT

A chassis assembly includes a chassis, a supporting bracket, and an anti-theft device. The chassis defines a slide slot. A stop hook is formed in the slide slot. The supporting bracket includes a stop block. The stop block slides into the slide slot and supports the chassis. The anti-theft device includes a slide plate, a pivoting member, a resilient member to rotate the pivoting member to an angle relative to the slide plate, and a fastener. A position hook extends from the pivoting member. When the pivoting member is parallel to the slide plate, the slide plate and the pivoting member enter the slide slot. The pivoting member is released when the slide plate abuts the stop block. The resilient member forces the position hook to engage with the stop hook. The pivoting member and the slide plate are held together with an anti-theft fastener.

### BACKGROUND

1. Technical Field

The present disclosure relates to an electronic device including an anti-theft device.

2. Description of Related Art

The development of the chassis of computers is towards miniaturization. However, the smaller the computer chassis, the easier it is to steal the computer.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, assembled view of an exemplary embodiment of a chassis assembly of an electronic device, wherein the chassis assembly includes an anti-theft device.

FIG. 2 is an isometric, exploded view of the items in FIG. 1.

FIG. 3 is an enlarged view of the anti-theft device of FIG. 2.

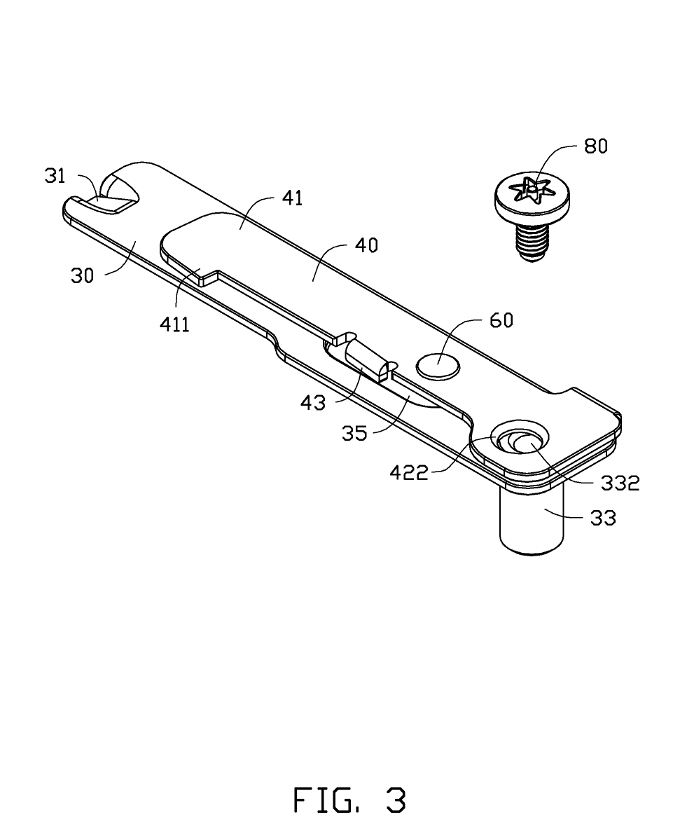

FIG. 4 is an isometric, exploded view of the device in FIG. 3.

FIG. 5 is a cross-sectional view taken along the line V-V of FIG. 1.

FIG. 6 is a cross-sectional view taken along the line VI-VI of FIG. 1.

FIG. 7 is similar to FIG. 6, but showing another state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

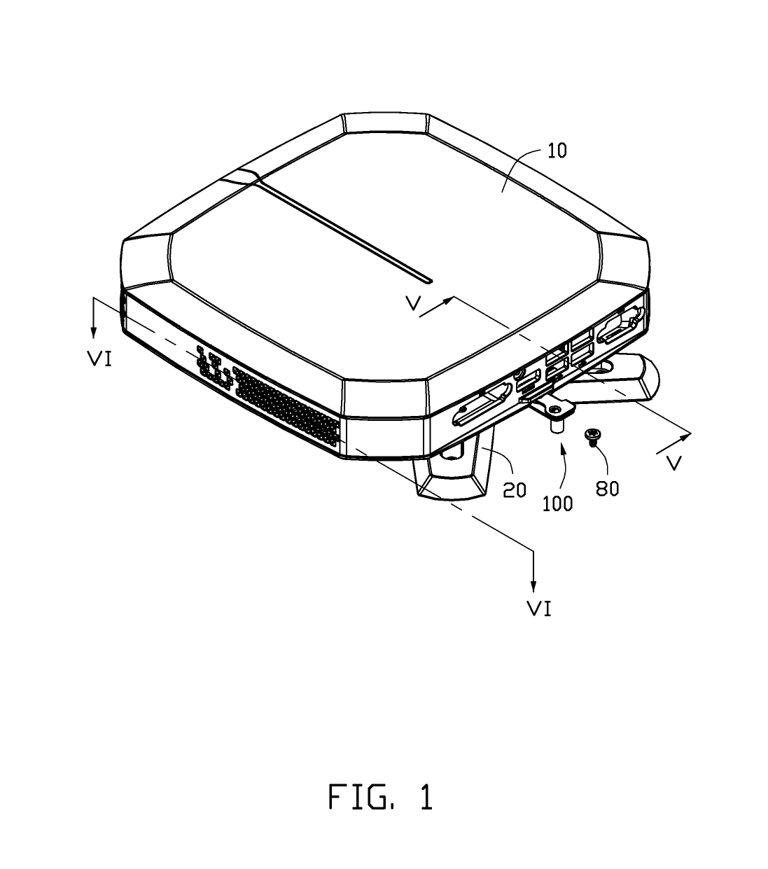

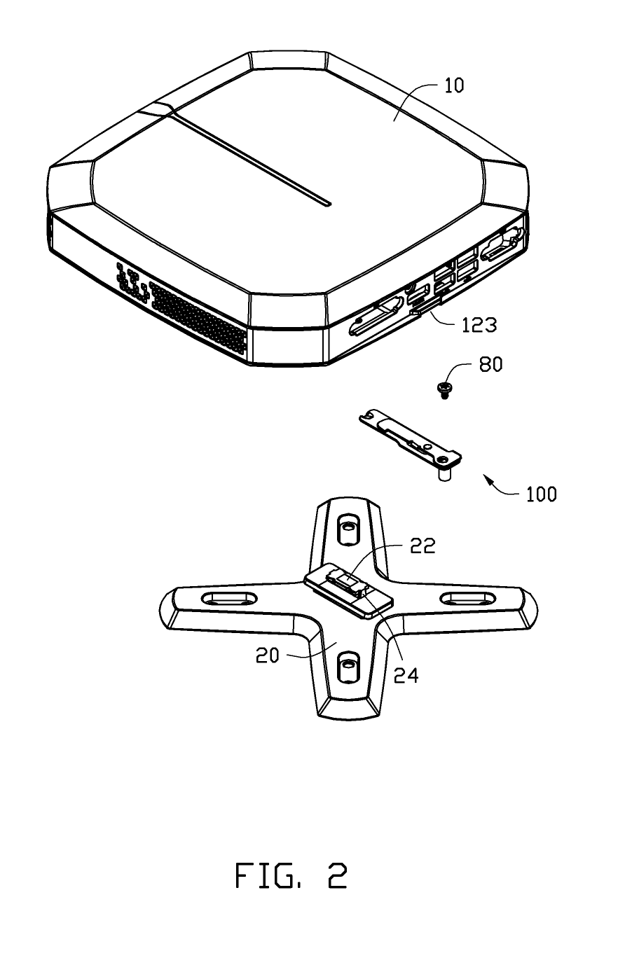

FIGS. 1, 2, and 4 show an exemplary embodiment of a chassis assembly including a chassis 10 of an electronic device (such as a computer), a supporting bracket 20, and an anti-theft device 100. The anti-theft device 100 includes a slide plate 30, a pivoting member 40, a resilient member 50, a rivet 60, and a fastener 80. In the embodiment, the resilient member 50 is a torsion spring with a first foot 51 and a second foot 52, and the fastener 80 is an anti-theft screw.

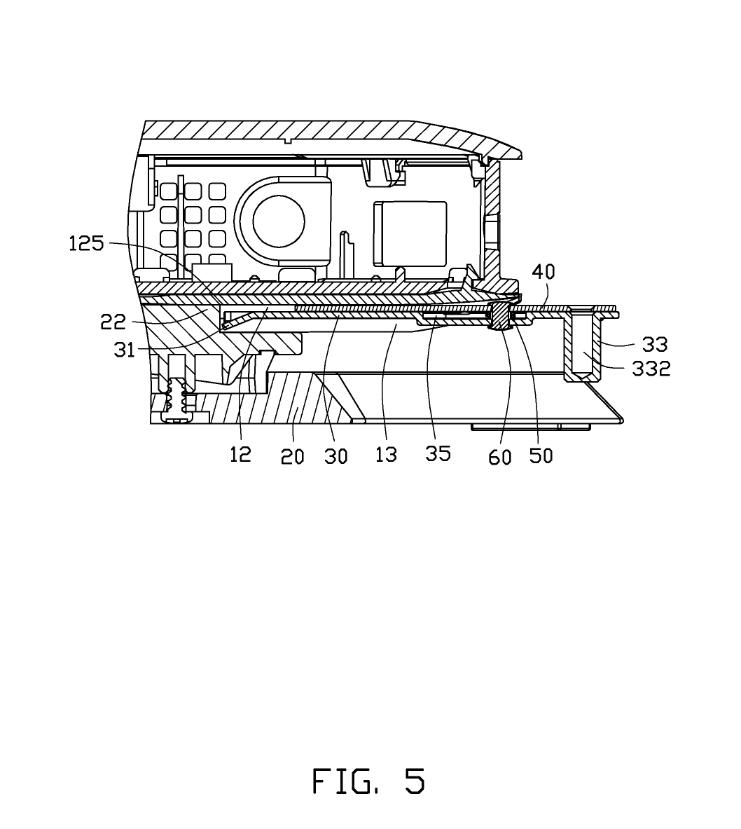

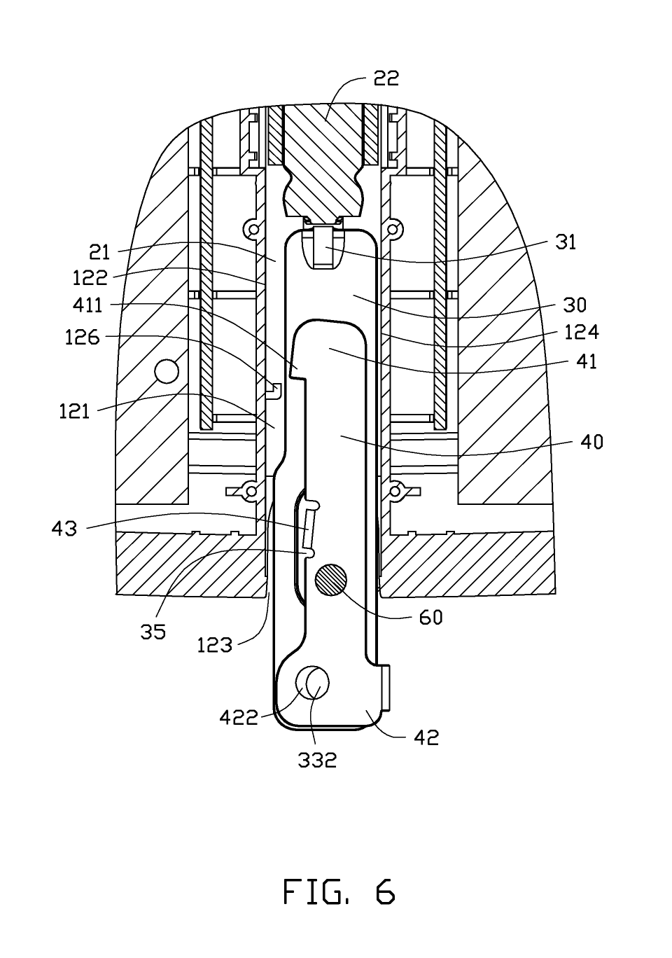

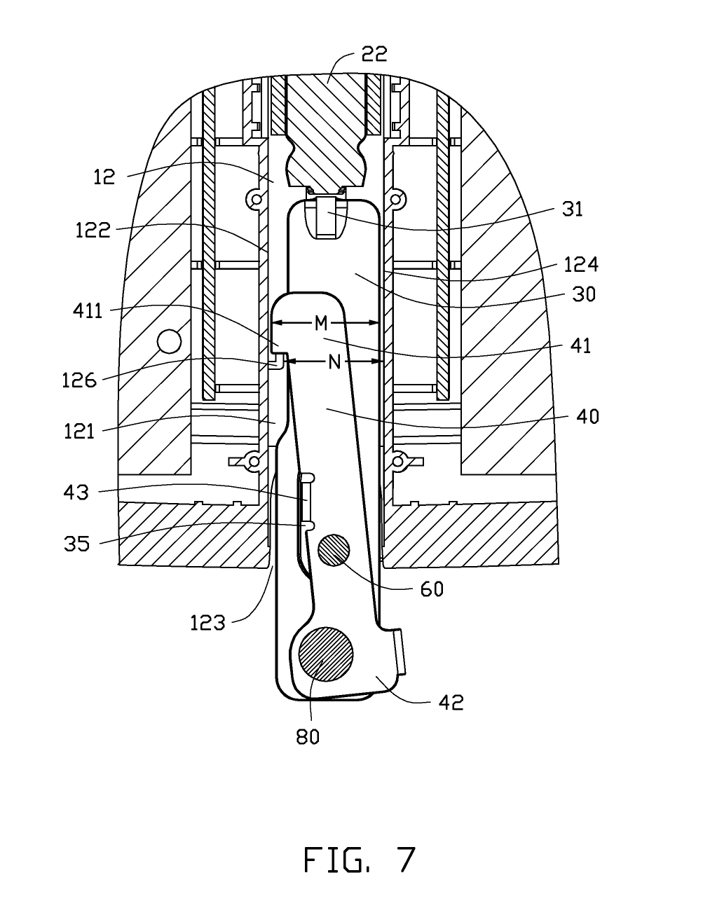

FIGS. 5-7 show the chassis 10 defining a long slide slot 12 extending through a first side of the chassis 10. The slide slot 12 includes a bottom wall 121, a top wall 125 opposite to the bottom wall 121, a front sidewall 122 connected between front sides of the top wall 125 and the bottom wall 121, and a rear sidewall 124 parallel to the front sidewall 122 and connected between rear sides of the top wall 125 and the bottom wall 121. The bottom wall 121 longitudinally defines an opening 13 extending through a bottom surface of the chassis 10. The slide slot 12 includes an inlet 123 located at the first side of the chassis 10. A substantially L-shaped stop hook 126 is formed on the bottom wall 121, adjoining the front sidewall 122 and opposite to the inlet 123.

The supporting bracket 20 includes a stop block 22 formed on a top of the supporting bracket 20, and a slide block 24 connected to a bottom of the stop block 22. The width of the slide block 24 is less than that of the stop block 22. The stop block 22 is wider than the opening 13. The slide block 24 is less than the opening 13 in width. The stop block 22 enters the slide slot 12 from the inlet 123, with the slide block 24 slidably received in the opening 13. The stop block 22 abuts the top wall 125, to allow the supporting bracket 20 to support the chassis 10.

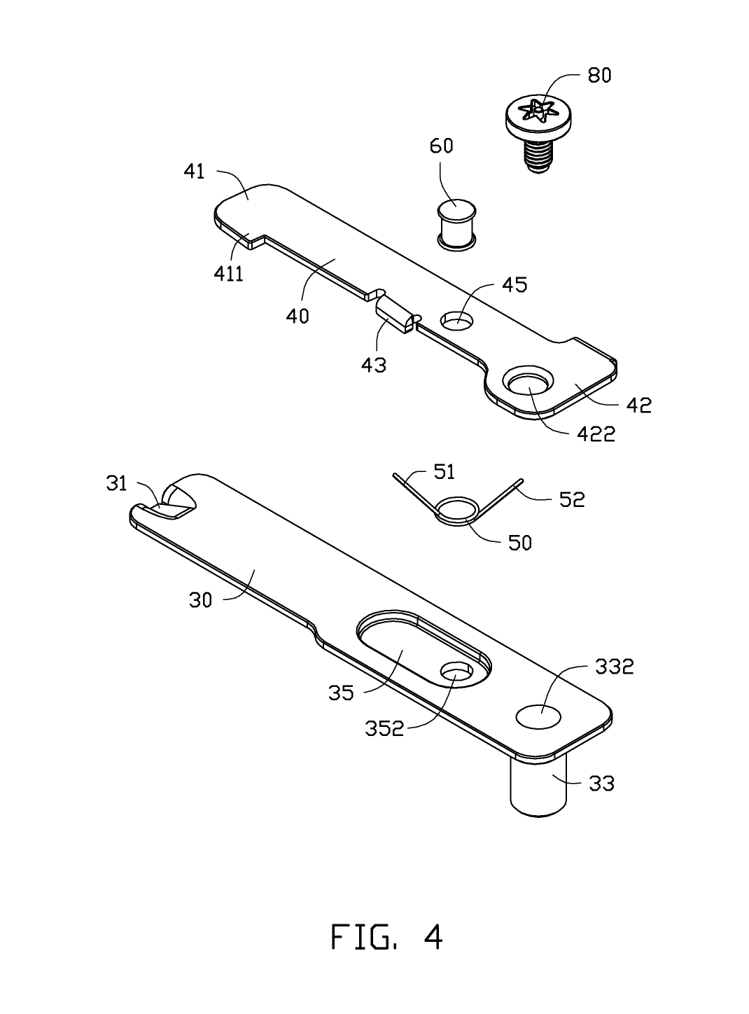

FIG. 4 shows a guiding portion 31 protruding down from a first end of the slide plate 30, and a locking pole 33 protruding down from a second end of the slide plate 30. The locking pole 33 longitudinally defines a locking hole 332 extending through a top surface of the slide plate 30. A recess 35 is defined in the top surface of the slide plate 30, near the second end of the slide plate 30. A through hole 352 is defined in a bottom wall of the recess 35, near the locking hole 332.

A position hook 411 extends forward from a front side of a first end 41 of the pivoting member 40. A stop tab 43 extends down from a middle of the front side of the pivoting member 40. A through hole 45 is defined in the pivoting member 40, located between the stop tab 43 and a second end 42 of the pivoting member 40. A through hole 422 is defined in the second end 42, in front of the through hole 45.

FIGS. 5, 6, and 7 the device in assembly, the resilient member 50 is placed on the bottom wall of the recess 35 and aligns with the through hole 352. The pivoting member 40 is placed on the slide plate 30, with the through hole 45 aligning with the through hole 352. The rivet 60 extends through the through hole 45, the resilient member 50, and the through hole 352, the opposite ends of the rivet 60 respectively block a top surface of the pivoting member 40 and a bottom surface of the slide plate 30. The first foot 51 abuts an inner side of the stop tab 43 and the second foot 52 abuts a sidewall of the recess 35, to bias the first end 41 of the pivoting member 40 a certain angle forward, such as 5 degrees and 10 degrees relative to the slide plate 30. The pivoting member 40 is rotated to parallel with the slide plate 30, and the resilient member 50 is deformed. The first end of the slide plate 30 is inserted into the slide slot 12 through the inlet 123. The guiding portion 31 slides in the opening 13 and guides the slide plate 30 to slide on the bottom wall 121. The first end of the slide plate 30 abuts the slide block 24. The pivoting member 40 is released, and the resilient member 50 restores, to urge the first end 41 of the pivoting member 40 to rotate toward the front sidewall 122. The position hook 411 engages with the stop hook 126. The through hole 422 aligns with the locking hole 332. The fastener 80 extends through the through hole 422 and engages in the locking hole 332. The distance M from a front side of the position hook 411 to a rear side of the slide plate 30 along a direction perpendicular to the front sidewall 122 is greater than the distance N from a rear side of the stop hook 126 to the rear sidewall 124 along the direction perpendicular to the front sidewall 122, to avoid the position hook 411 disengaging from the stop hook 126. Therefore, the chassis 10 cannot be disengaged from the anti-theft device 100 and the supporting bracket 20, thus reducing the likelihood of theft.

It is believed that the present embodiments and their advantages will be understood from the foregoing description, and various changes may be made thereto without departing from the spirit and scope of the description or sacrificing all of their material advantages, the examples hereinbefore described merely being embodiments.

What is claimed is:

1. An anti-theft device, comprising:
a slide plate;
a pivoting member rotatably connected to the slide plate, a position hook extending from a first end of the pivoting member;
a resilient member mounted between the slide plate and the pivoting member to bias the pivoting member to rotate the first end of the pivoting member forward a first certain angle relative to the slide plate; and
a fastener;
wherein the fastener is operable to fasten second ends of the pivoting member and the slide plate opposite to the position hook, after the first end of the pivoting member rotates forward a second certain angle relative to the slide plate.

2. The anti-theft device of claim 1, wherein a rivet extends through the pivoting member, the resilient member, and the slide plate to rotatably connect the pivoting member to the slide plate.

3. The anti-theft device of claim 2, wherein a recess is defined in a top surface of the slide plate and receives the resilient member, a stop tab extends from the pivoting member, a first foot of the resilient member abuts the stop tab, and a second foot of the resilient member abuts a sidewall of the recess.

4. The anti-theft device of claim 3, wherein the resilient member is a torsion spring.

5. The anti-theft device of claim 2, wherein a guiding portion protrudes down from an end of the slide plate away from the fastener.

6. The anti-theft device of claim 1, wherein the fastener is an anti-theft screw, extending through the pivoting member and engaging in the slide plate.

7. A chassis assembly, comprising:
a chassis defining a slide slot extending through a side of the chassis, a stop hook formed in the slide slot;
a supporting bracket comprising a stop block on a top of the supporting bracket, the stop block sliding into the slide slot through the side of the chassis to allow the supporting bracket to support the chassis; and
an anti-theft device comprising a slide plate, a pivoting member rotatably connected to the slide plate, a resilient member mounted between the slide plate and the pivoting member to bias the pivoting member to rotate a certain angle relative to the slide plate, and a fastener, a position hook extending from the first end of the pivoting member;
wherein when the pivoting member is rotated to be parallel to the slide plate, the slide plate and the pivoting member enter the slide slot, the pivoting member is released after the slide plate abuts the stop block, the resilient member is restored to bias the pivoting member to rotate to make the position hook engage with the stop hook, the fastener fastens second ends of the pivoting member and the slide plate opposite to the position hook.

8. The chassis assembly of claim 7, wherein a rivet extends through the pivoting member , the resilient member, and the slide plate to rotatably connect the pivoting member to the slide plate.

9. The chassis assembly of claim 8, wherein a recess is defined in a top surface of the slide plate and receives the resilient member, a stop tab extends from the pivoting member, a first foot of the resilient member abuts the stop tab, a second foot of the resilient member abuts a sidewall of the recess.

10. The chassis assembly of claim 9, wherein the resilient member is a torsion spring.

11. The chassis assembly claim 7, wherein an opening is longitudinally defined in a bottom wall of the slide slot extending through a bottom of the chassis, a guiding portion protrudes down from an end of the slide plate away from the fastener and slidably received in the opening.

12. The chassis assembly claim 7, wherein the stop hook is substantially L-shaped, facing the stop block.

13. The chassis assembly claim 7, wherein the supporting bracket comprises a slide block connected to a bottom of the stop block, when the stop block enters the slide slot, the slide block is slidably received in the opening.
